(19) United States
(12) Patent Application Publication
(10) Pub. No.: US 2026/0343006 A1
(43) Pub. Date: Oct. 29, 2026

(54) IMAGE PROCESSING METHOD AND ELECTRONIC DEVICE FOR PERFORMING IMAGE PROCESSING USING NEURAL NETWORK

(71) Applicant: SAMSUNG ELECTRONICS CO., LTD., Suwon-si (KR)

(72) Inventors: Jeongwon KIM, Suwon-si (KR); Seungeon KIM, Suwon-si (KR); Wonseop SONG, Suwon-si (KR); Wonhee LEE, Suwon-si (KR); Hochang RHEE, Suwon-si (KR); Woosuk CHOI, Suwon-si (KR); Dokwan OH, Suwon-si (KR)

(73) Assignee: SAMSUNG ELECTRONICS CO., LTD., Suwon-si (KR)

(21) Appl. No.: 19/538,094

(22) Filed: Feb. 12, 2026

(30) Foreign Application Priority Data
Apr. 23, 2025 (KR) 10-2025-0053309
Jun. 16, 2025 (KR) 10-2025-0079078

(51) Int. Cl. H04N 19/42; H04N 19/119; H04N 19/124; H04N 19/176; H04N 19/184; H04N 19/186; H04N 19/46

(52) U.S. Cl. CPC H04N 19/42; H04N 19/119; H04N 19/124; H04N 19/176; H04N 19/184; H04N 19/186; H04N 19/46

(57) ABSTRACT

An image processing method of an electronic device includes calculating representative values by dividing input image data into image blocks based on statistical characteristics corresponding to a type of the input image data, generating a residual image by removing the representative values from the image blocks, respectively, encoding, using a neural encoder, the residual image into a latent vector, and transmitting, to a neural decoder, the latent vector and the representative values.

### CROSS-REFERENCE TO RELATED APPLICATIONS

This application claims priority under 35 U.S.C. § 119 to Korean Patent Application No. 10-2025-0053309, filed on Apr. 23, 2025, and Korean Patent Application No. 10-2025-0079078, filed on Jun. 16, 2025, in the Korean Intellectual Property Office, the disclosures of which are incorporated by reference herein in their entireties.

### BACKGROUND

### 1. Field

The present disclosure relates generally to image processing, and more particularly, to an image processing method and an electronic device for performing image processing using a neural network.

### 2. Description of the Related Art

Recent developments of technologies using artificial neural networks may have led to significant advancements in neural network-based video compression (or encoding) and/or reconstruction (or decoding) technologies. For example, a neural encoder/decoder (codec) may learn features of input data using a neural network, encode the data for compression, and decode the compressed data for reconstruction. As the resolution of video and image data may continue to increase, reducing data traffic may have become a critical challenge.

### SUMMARY

One or more example embodiments of the present disclosure may address at least some of the above problems and/or disadvantages and/or other disadvantages not described above. Also, the embodiments may not be required to overcome the disadvantages described above, and an embodiment may not overcome any of the problems described above.

According to an aspect of the present disclosure, an image processing method of an electronic device includes calculating representative values by dividing input image data into image blocks based on statistical characteristics corresponding to a type of the input image data, generating a residual image by removing the representative values from the image blocks, respectively, encoding, using a neural encoder, the residual image into a latent vector, and transmitting, to a neural decoder, the latent vector and the representative values.

According to an aspect of the present disclosure, an image processing method of an electronic device includes receiving data including a latent vector and representative values corresponding to input image data, generating, using a neural decoder, a reconstructed residual image by inputting the latent vector into the neural decoder, and applying the representative values to the reconstructed residual image to generate a reconstructed image.

According to an aspect of the present disclosure, an electronic device for performing image processing includes at least one processor including processing circuitry, and memory storing a plurality of instructions. The plurality of instructions, when executed individually or collectively by the at least one processor, cause the electronic device to calculate representative values from image blocks of input image data set based on statistical characteristics of the input image data, generate a residual image by removing the representative values from the image blocks corresponding a type of the input image data, encode, using a neural encoder, the residual image into a latent vector, and transmit, to a neural decoder, the latent vector and the representative values.

Additional aspects may be set forth in part in the description which follows and, in part, may be apparent from the description, and/or may be learned by practice of the present disclosure.

### BRIEF DESCRIPTION OF THE DRAWINGS

The above and/or other aspects, features, and advantages of certain embodiments of the present disclosure may be more apparent from the following description taken in conjunction with the accompanying drawings, in which:

FIG. 1 is a diagram illustrating components of an electronic device for performing an image processing method, according to an embodiment;

FIG. 2 is a diagram illustrating the structure and operation of an electronic device, according to an embodiment;

FIG. 3 is a diagram illustrating operations of a preprocessing module and a preprocessing reconstruction module, according to an embodiment;

FIG. 4 is a flowchart illustrating an image processing method of an electronic device using a neural encoder, according to an embodiment;

FIG. 5 is a diagram illustrating a method of generating a residual image, according to an embodiment;

FIG. 6 is a diagram illustrating changes in the distribution of pixel values before and after removing representative values from input image data, according to an embodiment;

FIG. 7 is a diagram illustrating a method of generating a residual image, according to an embodiment;

FIG. 8 is a diagram illustrating a method of transmitting representative values to a neural decoder by an electronic device, according to an embodiment;

FIG. 9 is a flowchart illustrating an image processing method of an electronic device using a neural encoder, according to an embodiment;

FIG. 10 is a flowchart illustrating an image processing method of an electronic device using a neural decoder, according to an embodiment;

FIG. 11 is a flowchart illustrating an image processing method of an electronic device using a neural decoder, according to an embodiment;

FIG. 12 is a block diagram illustrating an electronic device for performing image processing using a neural encoder, according to an embodiment;

FIG. 13 is a block diagram illustrating an electronic device for performing image processing using a neural decoder, according to an embodiment; and

FIG. 14 is a diagram illustrating an image processing system, according to an embodiment.

### DETAILED DESCRIPTION

The following detailed structural or functional description is provided as an example only and various alterations and modifications may be made to the examples. Here, examples are not to be construed as limiting to the disclosure and should be understood to include all changes, equivalents, and replacements within the idea and the technical scope of the disclosure.

Terms, such as first, second, or the like, may be used herein to describe various components. Each of these terms may not be used to define an essence, order, or sequence of a corresponding component but may be used merely to distinguish the corresponding component from other components. For example, a first component may be referred to as a second component, and similarly the second component may also be referred to as the first component.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It may be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It may be further understood that terms, such as those defined in commonly used dictionaries, should be interpreted as having a meaning that may be consistent with their meaning in the context of the relevant art and may not be interpreted in an idealized or overly formal sense unless expressly so defined herein.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The embodiments described below may be used for, for example, a content providing device for providing video content, a video broadcasting device, a terminal device for performing video transmission in a video call or a video conference, and/or a mobile application processor (AP). However, embodiments of the present disclosure are not limited in this manner.

Hereinafter, various embodiments of the present disclosure are described with reference to the accompanying drawings. When describing the examples with reference to the accompanying drawings, like reference numerals may refer to like components and a repeated description related thereto may be omitted for the sake of brevity.

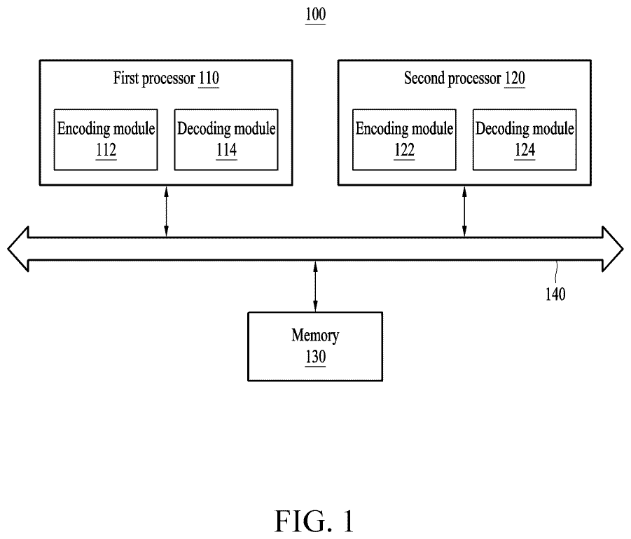

FIG. 1 is a diagram illustrating components of an electronic device for performing an image processing method, according to an embodiment. Referring to FIG. 1, an electronic device 100 may include a first processor 110, a second processor 120, and memory 130. The components of the electronic device 100 may communicate with each other via a communication bus 140. The first processor 110, the second processor 120, the memory 130, and the communication bus 140 may be included in a system-on-chip (SoC). A portion of the components may be omitted from the electronic device 100, or other components may be added thereto. For example, the electronic device 100 may include the first processor 110 and the memory 130 but may not include the second processor 120.

The first processor 110 and the second processor 120 may perform various types of processing and/or computation (e.g., on image data). As at least part of data processing and/or computation, the first processor 110 and the second processor 120 may store instructions and/or data received from other components in the memory 130, process the instructions and/or data stored in the memory 130, and store processing results in the memory 130. The first processor 110 and the second processor 120 may include, for example, a central processing unit (CPU), a graphics processing unit (GPU), a neural processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

The memory 130 may store various types of data used by components (e.g., the first processor 110 and the second processor 120) of the electronic device 100. The data may include, for example, a program (e.g., an application), and input image data and/or output data related thereto. The memory 130 may include volatile memory or non-volatile memory. The memory 130 may store instructions executable by the first processor 110 and/or the second processor 120. When the instructions stored in the memory 130 are executed by the first processor 110 and/or the second processor 120, the first processor 110 and/or the second processor 120 may perform the operations described herein.

The first processor 110 may include an encoding module 112 configured to generate encoded data by encoding data and/or a decoding module 114 configured to generate reconstructed data by decoding encoded data generated by another component (e.g., the second processor 120). The second processor 120 may include an encoding module 122 configured to generate encoded data by encoding data and/or a decoding module 124 configured to generate reconstructed data by decoding encoded data generated by another component (e.g., the first processor 110).

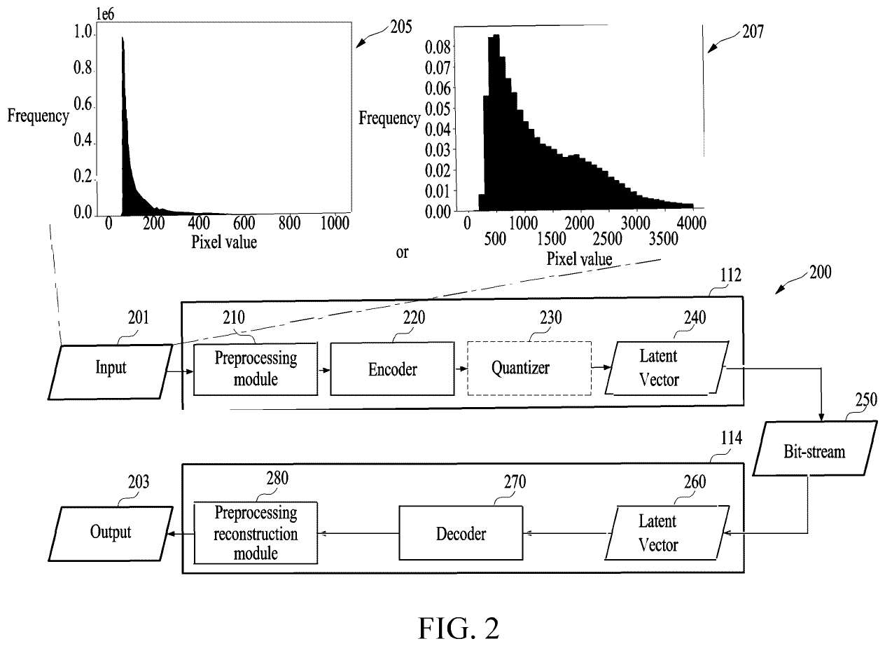

The encoding module 112 of the first processor 110 may generate encoded data by encoding input image data that is input to the encoding module 112. The input image data may include at least one of image data, video data, audio data, or any combination thereof. However, embodiments of the present disclosure are not necessarily limited thereto. If the input image data is an image, the input image data may include pixel values of pixels included in a local region (e.g., a block region) of an image. The encoding module 112 may include a neural network model-based encoder (e.g., an encoder 220 of FIG. 2) configured to transform input image data into vector data (e.g., a latent vector) value with fewer dimensions. The encoding module 112 may include one or a plurality of encoders.

The encoding module 112 may receive input image data, preprocess the input image data, and input the preprocessed data into a first encoder based on a neural network model, thereby calculating encoded data from the first encoder.

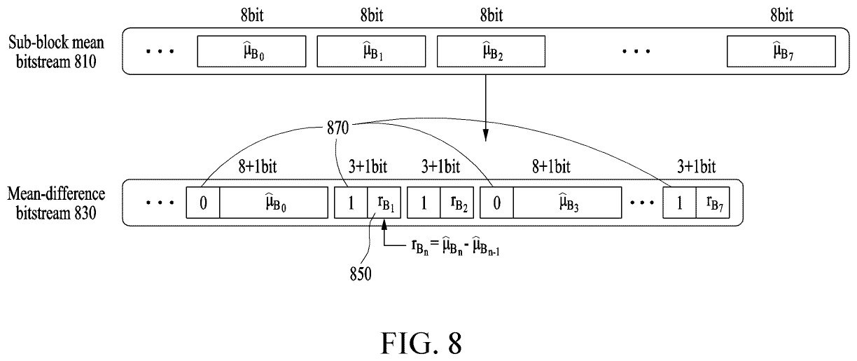

The encoded data generated by the first processor 110 may be transmitted from the first processor 110 to the second processor 120, or may be output from the first processor 110, stored in the memory 130 (e.g., a buffer memory within the memory 130), and then transmitted to the second processor 120. The encoded data may be transmitted to the memory 130 or the second processor 120 via the communication bus 140. The encoded data may be transmitted in the form of a bit stream (e.g., a bit stream 250 of FIG. 2 and/or a bit stream 810 or 830 of FIG. 8).

In some embodiments, the encoded data may be entropy-encoded by an entropy encoder and then transmitted in the form of a bit stream. As used herein, entropy encoding may refer to a coding method that may assign shorter codes to more frequent symbols according to the occurrence probabilities of the symbols corresponding to vector values grouped channelwise. In entropy encoding, shorter codes may be assigned to symbols that occur frequently, while longer codes may be assigned to symbols that occur less frequently. For example, statistical redundancy of input image data may be removed through entropy encoding.

The second processor 120 may receive encoded data and perform decoding based on the received encoded data to generate reconstructed data. The reconstructed data may also be referred to as “decoded data” or “decompressed data”.

If the second processor 120 receives a bit stream generated through entropy encoding, the decoding module 124 (e.g., a decoder 270 of FIG. 2) of the second processor 120 may perform entropy decoding on the received bit stream. Entropy decoding may be performed by an entropy decoder included in a decoding module. Encoded data included in a bit stream may be reconstructed through entropy decoding.

The decoding module 124 may perform decoding on the encoded data using a first decoder (e.g., the decoder 270 of FIG. 2) based on a neural network model, thereby obtaining reconstructed data corresponding to input image data.

In an encoding-decoding structure of data, one encoder and one decoder may be provided, but a plurality of encoders and a plurality of decoders may also be provided. If a plurality of encoders and a plurality of decoders are provided, each of the decoders may be paired with any one of the encoders. For example, if the encoders include a first encoder and a second encoder, the decoders may include a first decoder corresponding to the first encoder and a second decoder corresponding to the second encoder. In such an example, the first encoder and the first decoder may form a first pair, and the second encoder and the second decoder may form a second pair. The number of decoders may be equal to or less than the number of encoders. However, embodiments of the present disclosure are not necessarily limited thereto. For example, a plurality of encoders may be provided, while only one decoder may be provided.

In some embodiments, the encoding module 112 may receive input image data and input the received input image data into a first encoder, thereby calculating first vector data in which the input image data is encoded from the first encoder. The encoding module 112 may input the input image data into a second encoder based on a neural network model, thereby calculating second vector data in which the input image data is encoded from the second encoder.

The encoding module 112 may generate encoded data including a selected vector value and identification data for identifying a decoder to decode the selected vector value. The identification data may identify a decoder to perform decoding on each vector value included in the encoded data among a plurality of decoders corresponding to encoders or include a flag value or an index value for identifying a type of the transmitted data value. The flag value or index value of the identification data may be a value for identifying a corresponding encoder-decoder pair among a plurality of encoder-decoder pairs.

In some embodiments, the encoded data and the identification data generated by the first processor 110 may be transmitted from the first processor 110 to the second processor 120 and/or may be output from the first processor 110, stored in the memory 130 (e.g., a buffer memory within the memory 130), and then transmitted to the second processor 120. The encoded data and the identification data may be transmitted to the memory 130 and/or to the second processor 120 via the communication bus 140. The encoded data and the identification data may be transmitted in the form of a bit stream. In some embodiments, the encoded data and the identification data may be entropy-encoded by an entropy encoder and transmitted in the form of a bit stream.

The second processor 120 may perform decoding based on the received encoded data and identification data to generate reconstructed data. If the second processor 120 receives a bit stream generated through entropy encoding, the decoding module 124 of the second processor 120 may perform entropy decoding on the received bit stream. The decoding module 124 of the second processor 120 may receive the encoded data and the identification data, and select, based on the identification data, one of a plurality of decoders to decode a vector value included in the encoded data. The decoding module 124 may perform decoding on a vector value included in the encoded data using the selected decoder, thereby obtaining reconstructed data corresponding to the input image data. The decoding module 124 may identify a decoder to decode the encoded data from among a plurality of decoders based on a value (e.g., a flag value or an index value) of the identification data and perform a decoding process by inputting the encoded data to the identified decoder.

In the above embodiments, for ease of description, the encoding process is described as performed by the encoding module 112 of the first processor 110, and the decoding process as performed by the decoding module 124 of the second processor 120. However, embodiments of the present disclosure are not limited thereto. For example, the encoding process may be performed by the encoding module 122 of the second processor 120, and the decoding process may be performed by the decoding module 114 of the first processor 110.

The encoding modules 112 and 122 may each be referred to as a neural encoder, and the decoding modules 114 and 124 may each be referred to as a neural decoder. A neural encoder may be applied to various devices for compressing images (and/or videos), and a neural decoder may be applied to various devices for reconstructing compressed images (and/or videos). The encoding module 112 and the decoding module 114 may perform functions of a neural encoder/decoder (codec), and the encoding module 122 and the decoding module 124 may also perform functions of a neural codec.

The first processor 110 and/or the second processor 120, configured to perform functions of a neural codec, may be implemented in a personal computer (PC), a display device (e.g., a TV or a projector), a streaming service server, a content storage device, a portable device, or the like. The portable device may include, but not be limited to, for example, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, a smart device, or the like. The smart device may include, but not be limited to, for example, a smart watch, a smart band, a smart ring, or the like.

In an embodiment, the data processing between the first processor 110 and the second processor 120 may be performed in a frame buffer compression environment, in which image data and/or video data may be compressed between intellectual properties (IPs) (e.g., a GPU, an NPU, a video processor, or a display processor) within an SoC and transmitted via the memory 130 (e.g., dynamic random-access memory (DRAM)). The memory 130 may include a frame buffer configured to temporarily store compressed image data.

According to embodiments of the present disclosure, power consumption may be reduced by improving a data compression ratio and reducing a bandwidth between IPs and memory within an SoC, when compared to related image processing methods. When an image is transmitted in a compressed form, a block region, which may be a local region within the image, may be selected using a random-access technique that loads and processes only the necessary block region rather than the entire image, and a compression process may be performed on the selected block region.

Embodiments of the present disclosure may relate to image compression technology using a neural network and may be applied to frame buffer compression (FBC) based on a neural network model. FBC may reduce a DRAM bandwidth and save power by reducing the amount of data transmitted between IPs within an SoC, when compared to related image processing methods.

In addition, the embodiments of the present disclosure may employ lossy compression techniques that may allow for some errors from original data and provide a higher compression ratio than lossless compression with only a slight level of error that may be imperceptible to the human eye. The embodiments of the present disclosure may be trained on and applied to images of various formats, such as, but not limited to, Bayer pattern images, red-green-blue (RGB) images, and/or luminance-chrominance (YUV) images, and thus may provide relatively high scalability, when compared to related image processing methods.

The embodiments of the present disclosure may be applied not only to image compression but also to various applications having an encoder-decoder structure. For example, the embodiments of the present disclosure may be applied to systems with a limited number of dictionaries, such as, but not limited to, a vector quantized variational autoencoder (VQ-VAE) structure, and may also be applied to video compression and/or audio compression. The embodiments of the present disclosure may be used for data communication between modules within the same device and may also be used for data transmission between devices in wired and/or wireless communication environments. In addition, since the embodiments of the present disclosure may designed to process various data formats, they may be applied not only to compression of images and videos but also to compression of general data of other modalities.

FIG. 2 is a diagram illustrating the structure and operation of an electronic device, according to an embodiment. Referring to FIG. 2, an electronic device 200, according to an embodiment, includes an encoding module 112 including a neural encoder, and a decoding module 114 including a neural decoder and may perform encoding and/or decoding.

The encoding module 112 of FIG. 2 may include and/or may be similar in many respects to the encoding modules 112 and 122 described above with reference to FIG. 1, and may include additional features not mentioned above. Furthermore, the decoding module 114 may include and/or may be similar in many respects to decoding modules 114 and 124 described above with reference to FIG. 1, and may include additional features not mentioned above. Consequently, repeated descriptions of the encoding module 112 and the decoding module 114 described above with reference to FIG. 1 may be omitted for the sake of brevity.

The electronic device 200 may include, for example, a neural codec including a neural encoder and a neural decoder. However, embodiments of the present disclosure are not limited thereto. For example, a neural codec including a neural encoder and/or a neural decoder may be implemented on a mobile SoC equipped with an NPU.

The encoding module 112 may include, for example, a preprocessing module 210 and the encoder 220. Alternatively or additionally, the encoding module 112 may further include a quantizer 230.

The encoding module 112 may receive input image data 201. The input image data 201 may be and/or may include a Bayer pattern image having a pixel distribution as shown in graph 205, and/or a YUV image having a pixel distribution as shown in graph 207. However, embodiments of the present disclosure are not limited thereto. For example, the input image data 201 may be an RGB image.

The input image data 201 may correspond not only to image data but also to any data that may be represented in a two-dimensional form.

The encoding module 112 may include a preprocessing module 210 that may generate a residual image by removing representative values from the input image data 201 based on the statistical characteristics of each type of input image data. The preprocessing module 210 may quantize representative values and generate a residual image by removing the quantized representative values from image blocks. The preprocessing module 210 may transform an image with high statistical complexity into a form approximating a normal distribution (e.g., a latent vector form). The preprocessing module 210 may transmit a residual image, from which the quantized representative values have been removed, to the encoder 220.

The encoding module 112 may correspond to a neural network that may receive, as input to the encoder 220, a residual image with removed quantized representative values as generated by the preprocessing module 210. The encoding module 112 may perform quantization during the preprocessing performed by the preprocessing module 210 and/or may perform quantization using the quantizer 230 after encoding is performed by the encoder 220.

The quantizer 230 may perform quantization on the encoded result of the encoder 220 using various quantization techniques, such as, but not limited to, scalar quantization, vector quantization, embedded quantization, or the like. Alternatively or additionally, the quantizer 230 may apply a rounding operation, for example. The encoding module 112 including a neural encoder may be applied to various categories of products that may perform image (and/video) compression.

The encoding module 112 may generate a latent vector 240 corresponding to the input image data 201 by encoding, with the encoder 220, a residual image calculated by preprocessing the input image data 201 that has been preprocessed by the preprocessing module 210 to have the representative values removed.

The encoder 220 may extract features from a residual image with its representative values removed and generate a latent vector 240 with a reduced dimension. The encoding module 112 may perform quantization within the preprocessing module 210 and/or generate the latent vector 240 by quantizing the result encoded by the encoder 220 using a separate quantizer 230. The latent vector 240 may be, for example, a three-dimensional vector expressed in the form of {channel, height, width}. However, embodiments of the present disclosure are not necessarily limited thereto.

The encoder 220 may be configured as, for example, a convolutional neural network or a deep neural network. However, embodiments of the present disclosure are not necessarily limited thereto. As used herein, the encoder 220 may be referred to as an encoding network and/or a neural encoder.

In some embodiments, if reducing the dimension of the latent vector 240 alone does not sufficiently reduce the amount of information for effective compression, then the encoding module 112 may generate a latent vector 240 with reduced information through clipping and/or the quantizer 230. For example, if the dimensions of a latent vector outputted by the encoder 220 exceed a predetermined threshold, then the encoding module may further reduce the dimensions of the latent vector by performing clipping and/or quantization, using the quantizer 230, on the vector outputted by the encoder 220 to generate the latent vector 240.

The encoding module 112 may transmit a bit stream 250, which includes the latent vector 240, to the decoding module 114. The bit stream 250 may correspond to received data including a latent vector and representative values corresponding to input image data.

A neural decoder may be and/or may include a neural network configured to perform decoding using the decoder 270. In addition, the neural decoder may be applied to various product groups that perform image (and/video) reconstruction.

The decoding module 114 including a neural decoder may, when a latent vector 260 is received, reconstruct the latent vector 260 using the decoder 270, and then reconstruct (add) a representative value using a preprocessing reconstruction module 280 to generate output data 203.

The decoding module 114 may generate a reconstructed residual image by inputting the received latent vector 260 into the decoder 270. As used herein, the decoder 270 may be referred to as a decoding network or a neural decoder.

The decoding module 114 may provide the residual image reconstructed by the decoder 270 to the preprocessing reconstruction module 280. The preprocessing reconstruction module 280 may generate a reconstructed image corresponding to the output data 203 by adding back the representative values removed during the preprocessing process to the reconstructed residual image.

The electronic device 200 may train the encoder 220 and the decoder 270 based on a difference between the input image data 201 and the output data 203 that is reconstructed by the decoder 270.

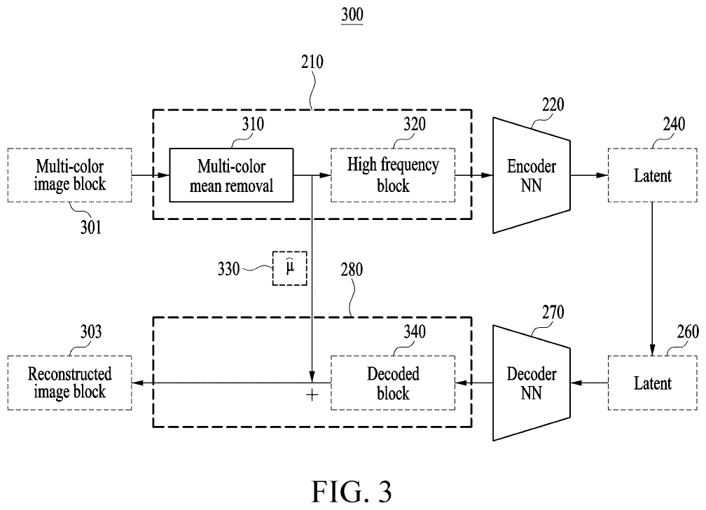

FIG. 3 is a diagram illustrating operations of a preprocessing module and a preprocessing reconstruction module, according to an embodiment. Referring to FIG. 3, drawing 300 illustrates a process in which an electronic device (e.g., electronic devices 100 or 200, according to an embodiment, compresses and transmits a multi-color image block 301 using a neural network (e.g., the encoder 220), and then decompresses the data to generate a reconstructed image block 303 using another neural network (e.g., the decoder 270).

The neural networks (e.g., the encoder 220 and the decoder 270) may perform compression and decompression using a lossy compression technique at an image block level.

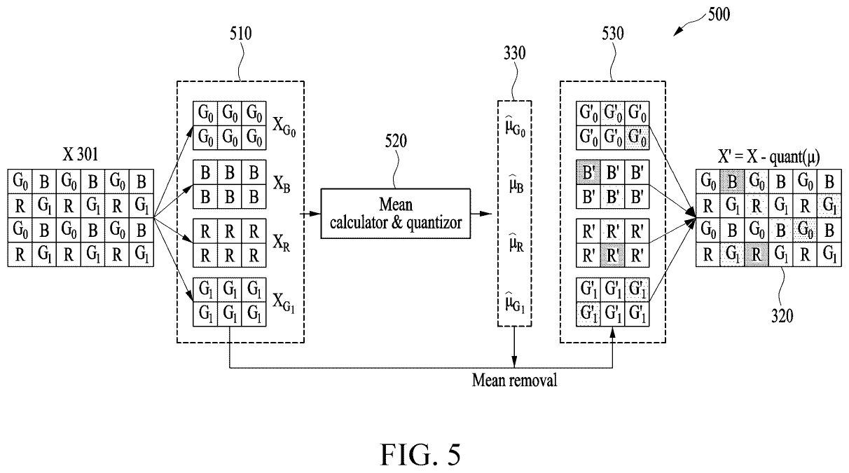

The electronic device may generate a residual image 320 by removing a plurality of representative values (e.g., a mean value \hat{μ} 330) from the multi-color image block 301, which may be the original image, through multi-color mean removal 310 performed by the preprocessing module 210. For example, the residual image 320 may correspond to a high-frequency image block. The multi-color mean removal 310 may be performed, for example, by a mean calculator and quantizer 520 as described with reference to FIG. 5.

The electronic device may extract mean values \hat{μ} 330 of pixels from sub-blocks of the multi-color image block 301 and compress the residual image 320 calculated by removing the mean values, to transform an input image (e.g., the multi-color image block 301) into a form suitable for neural network learning. That is, the electronic device may perform preprocessing to calculate and remove a plurality of representative values for each color and/or position from sub-blocks of a single image block.

In some embodiments, the sub-blocks of the single image block may be set differently according to the statistical characteristics of the input image (e.g., the multi-color image block 301). For example, if the input image is a Bayer pattern image in which R, G₀, G₁, and B colors collected through a camera sensor arranged on a single plane, the electronic device may divide the input image into multi-color image blocks 301 based on statistical characteristics according to the type of the input image and extract representative values (e.g., the mean value \hat{μ} 330) by color.

For example, in a Bayer pattern image including R, G₀, G₁, and B colors, the distribution of pixel values may differ by color, and thus compressing the image in its original form may result in a low compression ratio due to reduced data redundancy. In addition, when adjacent pixel values differ significantly, artifacts may appear near boundaries in reconstructed images. Such artifacts may appear because neural networks with mean-based loss functions may be vulnerable to learning data with non-Gaussian distributions. Therefore, in an embodiment, the data may be transformed to approximate a Gaussian distribution by removing different mean values for each color (channel) or position, even when multiple colors are present simultaneously.

In some embodiments, the electronic device may extract representative values (e.g., the mean value \hat{μ} 330) at a sub-block level based on pattern changes depending on positions within image blocks. The electronic device may divide image blocks into a plurality of sub-blocks and calculate representative values as mean values of the respective sub-blocks.

For image preprocessing suitable for neural network training, the electronic device may generate the residual image 320 by removing mean values for each color (channel) and/or position from the multi-color image block 301.

The electronic device may input the residual image 320 into the encoder 220 to calculate the latent vector 240. For example, the encoder 220 may be trained to encode the latent vector 240 into a fixed-range integer type (e.g., 8-bit integer).

The electronic device may transmit the mean value \hat{μ} 330 calculated in the multi-color mean removal 310, together with the latent vector 240, to the decoder 270. The mean value \hat{μ} 330 may correspond to a value calculated through a quantization process, that is, a quantized mean value. The mean value \hat{μ} 330 may be and/or may include a mean value for each color (channel) and/or position within image blocks. The transmission of the mean value \hat{μ} 330 may require additional bits.

The electronic device may perform quantization by reducing the bit depth of the mean value \hat{μ} 330, thereby adjusting the amount of transmission. As used herein, the bit depth may refer to the precision and/or range of data represented in bits. For example, the bit depth may indicate how much information each element of data may contain. A greater (larger) bit depth may allow each element of data to contain more information. As another example, the depth may indicate the number of bits used to represent a vector value (e.g., a latent vector value) contained in encoded data, and the size and precision of the vector value may be determined by a specified bit depth.

Reducing bit depth may reduce the amount of transmission but may also degrade compression performance. The electronic device may adjust the bit depth for quantization (e.g., the quantization level) through training.

Since the encoder 220 compresses the residual image 320 with the mean value \hat{μ} 330 removed, a receiving side (e.g., the decoder 270 side) may complete the reconstructed image block 303 by adding the mean value \hat{μ} 330 to a residual image 340, which is reconstructed by the decoder 270 and then processed by the preprocessing reconstruction module 280. In some embodiments, the electronic device may transmit the mean value \hat{μ} 330 together with the latent vector 240 to the receiving side.

When transmitting the mean value \hat{μ} 330 to the decoder 270, the electronic device may reduce the length of a bit stream by transmitting, together with a flag, a difference (or residual) between adjacent values (e.g., neighboring sub-blocks).

The decoder 270 may generate the reconstructed residual image 340 by receiving the transmitted latent vector 260. The reconstructed residual image 340 may also be referred to as a decoded block in that it is a residual image reconstructed through decoding by the decoder 270. The electronic device may generate the final reconstructed image block 303 by adding the mean value \hat{μ} 330 to the reconstructed residual image 340.

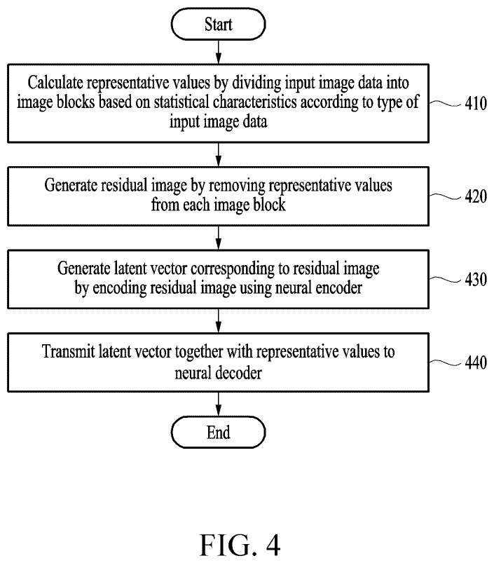

FIG. 4 is a flowchart illustrating an image processing method of an electronic device using a neural encoder, according to an embodiment. Operations to be described hereinafter may be performed sequentially but not necessarily performed sequentially. For example, the order of the operations may change and at least two of the operations may be performed in parallel.

Referring to FIG. 4, the electronic device (e.g., the electronic device 100 or 200), according to an embodiment, may transmit a latent vector, together with representative values, to a neural decoder through operations 410 to 440. The electronic device, according to an embodiment, may perform image processing, including encoding and decoding, using a neural network (e.g., a neural encoder and/or a neural decoder such as, but not limited to, the encoding modules 112 and 122 and encoder 220 and/or the decoding modules 114 and 124 and decoder 270).

In operation 410, the electronic device may calculate representative values by dividing input image data into image blocks based on the statistical characteristics of each type of input image data. The input image data may be and/or may include an image data block or a plurality of sub-blocks.

The type of input image data may include, but is not limited to, a Bayer pattern image, a YUV image, an RGB image, a grayscale image, a binary image, an indexed color image, a hue, saturation, and value (HSV) image, or the like. A Bayer pattern image may correspond to an image captured using a filter array method employed in the image sensor of a digital camera. A Bayer pattern image may be obtained by arranging RGB filters of the image sensor in a specific pattern such that each pixel is configured to detect only one color. A Bayer pattern may be configured to reflect human visual characteristics, with the green (G) filter accounting for approximately 50% of the total amount of RGB filters, and the red (R) and blue (B) filters each accounting for approximately 25% of the total amount of RGB filters.

A YUV image may refer to an image format that represents image data based on the visual characteristics of the human eye and may include a luminance (luma) component, denoted by Y, for brightness, and two chrominance components, denoted by U and V, for color differences. The U may indicate the chrominance difference relative to the blue component, and the V may indicate the chrominance difference relative to the red component.

An RGB image may refer to an image represented using three primary color components: red (R), green (G), and blue (B). An RGB image may be based on the three primary colors of light, and each pixel may include a combination of three-color components. The RGB values of each pixel may be represented by numbers ranging from 0 to 255, allowing various colors to be expressed. However, embodiments of the present disclosure are not limited in this regard, and different number ranges may utilized to represent the colors in the RGB image.

A grayscale image may refer to a black-and-white image in which each pixel has only a brightness value and may generally be represented using eight (8) bits. For example, the brightness value of each pixel in a grayscale image may range from 0 (black) to 255 (white). However, embodiments of the present disclosure are not limited in this regard, and different number ranges may utilized to represent the brightness in the grayscale image.

A binary image may refer to an image in which each pixel may only have two (2) values (e.g., representing white and black) and may be represented using one (1) bit per pixel. A binary image may be mainly used to distinguish object boundaries or shapes.

An indexed color image may not store color information directly but may represent colors using a color palette (color table). In an indexed color image, each pixel may indicate an index in the color palette and may typically be represented using eight (8) bits.

An HSV image may refer to an image composed of hue (H), saturation(S), and value (V) values, and may represent color information using cylindrical-coordinate representations of points in a device-dependent RGB color model. For example, in each cylinder, the angle around the central vertical axis may correspond to the hue, the distance from the axis may correspond to the saturation, and the distance along the axis may correspond to the value (e.g., lightness, brightness, or the like).

The statistical characteristics according to the type of input image data may refer to distributions of pixels that differ depending on the type of input image data, as described above with reference to FIG. 2. However, embodiments of the present disclosure are not necessarily limited thereto. For example, a Bayer pattern image may exhibit an interleaved distribution in which pixel values frequently occur at positions near 100. In addition, the Y channel of a YUV image may exhibit a heavy-tailed distribution. As such, statistical characteristics (e.g., a pixel distribution) may vary depending on the type of input image data.

The electronic device may divide input image data into image blocks based on the statistical characteristics of each type of input image data. Representative values may include, for example, the mean, mean square, variance, or variance square of pixel values of image blocks. However, embodiments of the present disclosure are not necessarily limited thereto. The electronic device may calculate a representative value for each of the image blocks.

The electronic device may determine image blocks from which representative values are to be calculated, based on the statistical characteristics of each type of input image data as described above. The electronic device may, for example, divide image blocks for each color (channel) and/or position, and calculate representative values from each of the image blocks. The electronic device may divide image blocks into a plurality of sub-blocks and calculate representative values as mean values of the respective sub-blocks.

The electronic device may determine image blocks based on channels of the input image data and/or determine image blocks by dividing the input image data into a plurality of sub-blocks based on positions.

The electronic device may, for example, determine image blocks for each channel (or pixel color) of the input image data, as illustrated in FIG. 5 below. As used herein, the term channel may refer to an independent data stream that may store color information for each pixel in the image. An image may include multiple channels, each of which may represent specific color and/or luminance information. Channels may include, but are not limited to, RGB channels, alpha channels, YUV channels, and grayscale channels. An RGB channel may include three separate channels (e.g., red (R), green (G), and blue (B)). Each channel may represent the intensity of the corresponding color, and the red, green, and blue channels may be combined to form a final color. The alpha channel may represent transparency and may store the opacity value of each pixel. A YUV channel may include three channels (e.g., Y (luminance), U (chrominance: blue minus luminance), and V (chrominance: red minus luminance)). That is, a YUV image may separate color information into luminance and chrominance components. The Y channel may correspond to the luminance (luma) component and may represent the brightness of a color. The U and V channels may correspond to chrominance components, and the two channels (e.g., U and V) together may determine the color. Unlike RGB channels, the U and V channels in a YUV channel may not specify individual colors separately but may work together to define a single color. In some embodiments, the U channel may be associated with blue, and the V channel may be associated with red. However, embodiments of the present disclosure are not necessarily limited thereto.

The electronic device may calculate representative values as mean values of the channel values. The channel values of each image block may be, for example, RGB color values, pixel resolution values, or color depth values. However, embodiments of the present disclosure are not necessarily limited thereto. A resolution value may indicate the number of pixels displayed on a screen and may generally be expressed as the number of horizontal pixels multiplied by the number of vertical pixels. A color depth value may indicate the number of colors that each pixel may represent and may generally expressed in bits. For example, a color depth of 24 bits may represent approximately 16.7 million colors. These pixel values may collectively form an image, and higher resolution and color depth typically provide sharper and/or more detailed images.

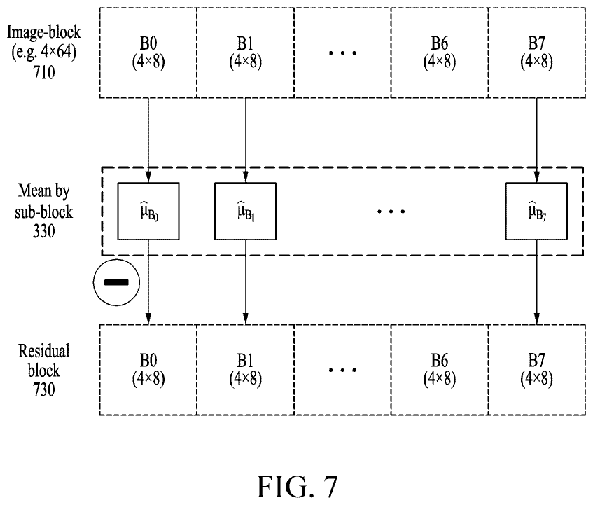

Alternatively or additionally, the electronic device may determine image blocks by dividing input image data into a plurality of sub-blocks, as illustrated in FIG. 7 below. For example, the electronic device may calculate representative values by averaging a plurality of sub-blocks according to their positions.

In operation 420, the electronic device may generate a residual image by removing the representative values calculated in operation 410 from each image block. The electronic device may perform image preprocessing suitable for neural network training by removing representative values (e.g., a mean value) from each image block. Removing representative values from each image block may correspond to the removal of low-frequency components. Therefore, the residual image generated in operation 420 may correspond to high-frequency components of image blocks.

In operation 420, the electronic device may quantize representative values and remove the quantized representative values from the image blocks to generate a residual image. The electronic device may quantize representative values by dynamically adjusting the bit depth of quantization for each color of the image blocks according to the type of input image data. A method in which an electronic device generates a residual image by quantizing representative values for each color of image blocks is described below with reference to FIG. 5.

In addition, the electronic device may quantize representative values by dynamically adjusting the bit depth of quantization for each position of the image blocks according to the type of input image data. A method in which an electronic device generates a residual image by quantizing representative values for each position of image blocks is described below with reference to FIG. 7.

The electronic device may control the amount of data by dynamically adjusting the level of quantization for each color and/or position of image blocks according to the type of input image data, thereby quantizing representative values.

In addition, the electronic device may reduce the length of a bit stream by removing a certain number of least significant bits (LSBs) from the bit stream representing representative values. The electronic device may reduce the amount of transmission by quantizing the reduced bit stream. For example, the electronic device may reduce a bit stream of eight (8) or twelve (12) bits to four (4) or eight (8) bits by removing four (4) LSBs from the bit stream representing the representative values.

In some embodiments, the electronic device may also adjust (the magnitude of) the quantized representative values. The electronic device may adjust the quantized representative values by, for example, removing a certain value or by removing a certain number of LSBs as described above. The electronic device may generate a residual image by removing the adjusted representative values from the image blocks.

In operation 430, the electronic device may generate a latent vector corresponding to the residual image by encoding the residual image generated in operation 420 using a neural encoder (e.g., encoding module 112, encoding module 122, or encoder 220).

In operation 440, the electronic device may transmit the latent vector generated in operation 430, together with the representative values, to the neural decoder (e.g., decoding module 114, decoding module 124, or decoder 270). The electronic device may transmit the latent vector generated in operation 430, together with the quantized representative values, to the neural decoder.

In some embodiments, the electronic device may transmit the latent vector, a difference value between the representative values generated in operation 430, the previously transmitted representative values, and a flag to the neural decoder.

For example, if the difference value is less than a reference value (e.g., three (3) bits), the electronic device may transmit the difference value, together with a flag indicating a first value (e.g., one (‘1’)), to the neural decoder. For example, the flag indicating the first value may indicate that the value transmitted to the neural decoder corresponds to the difference value (between the representative values and the previously transmitted representative values). Alternatively, if the difference value is greater than or equal to the reference value, the electronic device may transmit the representative values together with a flag indicating a second value (e.g., zero (‘0’)) to the neural decoder. For example, the flag indicating the second value may indicate that the values transmitted to the neural decoder are the representative values. However, embodiments of the present disclosure are not limited in this regard, and the flag may indicate additional and/or different values. A method in which an electronic device transmits a difference value to a neural decoder together with a flag is described below with reference to FIG. 8.

FIG. 5 is a diagram illustrating a method of generating a residual image, according to an embodiment. FIG. 5 includes drawing 500 illustrating a process in which an electronic device, according to an embodiment of the present disclosure, generates a residual image X′ 320 by removing a representative value (e.g., the mean value \hat{μ} 330) from an original image X 301, which is an example of input image data.

The original image X 301 may correspond to, for example, a Bayer pattern image in which four (4) colors (e.g., red R, first green G₀, second green G₁, and blue B) are regularly arranged. A Bayer pattern image may have relatively low data redundancy due to differences in pixel value distributions by color, which may lead to a reduced compression ratio and image degradation. The electronic device may cause the pixel distribution to approximate a Gaussian distribution by removing a mean value from the image of each color.

The electronic device may separate the original image X 301 into image blocks 510 (e.g., a first green image block X_{G}_{₀}, a blue image block XB, a red image block XR, and a second green image block X_{G1}) corresponding to the four (4) colors R, G₀, G₁, and B. The electronic device may calculate quantized mean values 330 (e.g., a first green quantized mean value \hat{μ} G₀, a blue quantized mean value \hat{μ} _{B}, a red quantized mean value \hat{μ} _{R}, and a second green quantized mean value \hat{μ} _{G}_{₁}) by quantizing mean values of the image blocks 510, respectively, for each color using a mean calculator and quantizer 520.

The electronic device may obtain the quantized mean values 330 by removing LSBs from a bit stream representing the mean values of the image blocks 510 for each color until a desired bit depth is achieved.

For example, the electronic device may calculate colorwise mean values of 10-bit Bayer pattern image blocks having a size of 4×32. In such an example, the electronic device may divide an image of size 4×32 into image blocks of size 2×16, calculate a mean value, and then remove LSBs until a predetermined bit depth (e.g., eight (8) bits) is achieved. In some embodiments, the electronic device may set different bit depths of quantization for each of the colors (e.g., red R, first green G0, second green G₁, and blue B).

As such, the electronic device may dynamically adjust the bit depth of quantization for each color of image blocks according to the type of input image data and quantize representative values (e.g., the mean values 330 of the image blocks 510 for each color).

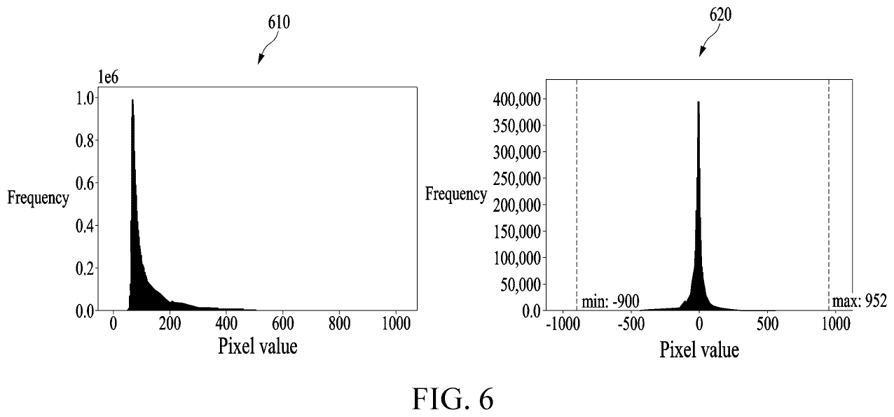

The electronic device may generate residual images 530 (e.g., a first green residual image G′₀, a blue residual image B′, a red residual image R′, and a second green residual image G′₁) for each color by performing mean removal, that is, by removing the quantized mean values 330 from the corresponding colorwise image blocks 510 of the original image X 301. The electronic device may generate the residual image X′ 320 of high-frequency components by combining (or rearranging) the residual images 530 for each color. The electronic device may remove the first green quantized mean value \hat{μ} _{G}_{₀} from the first green image block X_{G}_{₀} corresponding to the first green color G₀ to generate the first green residual image G₀. The electronic device may remove the blue quantized mean value \hat{μ} _{B} from the blue image block X_{B} corresponding to the blue color B to generate the blue residual image B′. The electronic device may remove the red quantized mean value \hat{μ} _{R} from the red image block X_{R} corresponding to the red color R to generate the red residual image R′. The electronic device may remove the second green quantized mean value \hat{μ} _{G}_{₁} from the second green image block X_{G}_{₁} corresponding to the second green color G₁ to generate the second green residual image G′₁. For example, the result of removing the quantized mean values 330 from the corresponding image blocks 510 for each color may be shown in the graph of FIG. 6 below.

The electronic device may rearrange the residual images 530 for each color, with the quantized mean values 330 removed, into an original Bayer pattern format to generate the final residual image X′ 320. That is, the final residual image X′ 320 may have a Bayer pattern format.

In an embodiment, a quantization level may be set differently for each color when quantizing the mean values of the image blocks 510 for each color. For example, when the size of the original image X 301 is twelve (12) bits (e.g., representing values from zero (0) to 4,095), the quantized mean values 330 may also be 12-bit values. However, the electronic device may set different quantization levels (e.g., bit depths) for each color. The electronic device may dynamically set quantization bit depth for each color based on a range of pixel values in a high-frequency image, such as the residual image X′ 320.

For example, the electronic device may quantize the first green quantized mean value \hat{μ} _{G}_{₀}0 from the first green image block X_{G}_{₀} and the second green quantized mean value \hat{μ} _{G}_{₁} from the second green image block X_{G}_{₁} to eight (8) bits (e.g., representing values from zero (0) to 255) and quantize the blue quantized mean value \hat{μ}_{B} from the blue image block X_{B} and the red quantized mean value \hat{μ} _{R} from the red image block X_{R} to ten (10) bits (e.g., representing values from zero (0) to 1,023). As such, the electronic device may enable more precise reconstruction of the image blocks X_{B} and X_{R} by quantizing the image blocks X_{B} and X_{R} with a greater bit depth. For example, if the original image has values within twelve (12) bits (e.g., values from zero (0) to 4,095), the mean value may also fall within that range. Since a residual is calculated as a difference between the original value and the mean value (e.g., original—mean), the residual value may range from a minimum of −4,095 to a maximum of +4,095. For example, a minimum residual may correspond to a case in which the mean value is set to a relatively large value (e.g., a value close to the maximum value of 4,095, such as, 4,094.xxxx) and a pixel value in the original image is set to a relatively small value (e.g., a value close to or the same as the minimum value of zero (0)). As another example, a maximum residual may correspond to a case in which the mean value is set to a relatively small value (e.g., a value close to the minimum value of zero (0), such as, 0.xxxx) and a pixel value in the original image is set to a relatively large value (e.g., a value close to or the same as the maximum value of 4,095). As a result, the residual image X′ 320 may be expressed in thirteen (13) bits. However, embodiments of the present disclosure are not limited in this regard, and different number of bits, as well as, different maximum and/or minimum values may be used without departing from the scope of the present disclosure.

FIG. 6 is a diagram illustrating changes in the distribution of pixel values before and after removing representative values from input image data, according to an embodiment. Referring to FIG. 6, a first graph 610 and a second 620 show changes in the distribution of pixel values before and after removing representative values (e.g., a mean value) from an image block of a Bayer pattern image having a size of 256 pixels in width and four (4) pixels in height, according to an embodiment.

The first graph 610 illustrates an example of a distribution of pixel values before removing representative values (e.g., a mean value) from the image block. In an embodiment, the distribution of pixels may be represented as an asymmetric distribution of pixels skewed to one side (e.g., to the left). When pixels exhibit an asymmetric distribution, as shown in the first graph 610, the unpredictability of a neural network may increase, which may degrade compression performance and increase the likelihood of artifacts.

In an embodiment, as described above with reference to FIG. 5, representative values (e.g., a mean value) may be removed from an image block such that the pixels exhibit a symmetrical distribution, such as a Gaussian distribution centered around zero, as shown in the second graph 620. As a result, the predictability of the neural network may be increased, thereby improving compression performance and reducing the likelihood of artifacts, when compared to related image processing methods.

FIG. 7 is a diagram illustrating a method of generating a residual image, according to an embodiment. Referring to FIG. 7, diagram 700 illustrates a method of generating a residual image for each position in a YUV image by an electronic device (e.g., the electronic device 100 or 200), according to an embodiment.

The electronic device may generate a residual image by dividing an image block of a YUV image, which may be an example of input image data, into sub-blocks and removing quantized mean values. In an embodiment, input image data may be divided into sub-blocks, and representative values (e.g., a mean value) may be removed to improve compression performance, particularly in edge regions, when compared to related image processing methods.

The electronic device may, for example, divide an 8-bit image block 710 having a size of four (4) pixels in height by 64 pixels in width into eight (8) sub-blocks (e.g., a first sub-block B0, a second sub-block B1, to a seventh sub-block B6, and an eighth sub-block B7), in which each sub-block has a size of four (4) pixels in height by eight (8) pixels in width. However, embodiments of the present disclosure are not limited in this regard, and the image block 710 may be divided in a different number of sub-blocks and/or into sub-blocks having different sizes. For example, pixel distributions may vary depending on positions within a single image block 710. Therefore, the electronic device may improve compression performance by removing mean values for each of the eight sub-locks B0 to B7, instead of removing a single mean value for the entire image block 710. In some embodiments, the sub-blocks may be adjusted to various sizes, such as, but not limited to, 4×4, 4×16, or the like.

The electronic device may calculate and quantize mean values \hat{μ}330 for each of the eight (8) sub-block to calculate the quantized mean values 330 (e.g., a first quantized mean value \hat{μ} _{B}_{₀}, a second quantized mean value \hat{μ} _{B}_{₁}, to an eighth quantized mean value \hat{μ} _{B}_{₇}).

The electronic device may generate a residual block 730 by combining residual image blocks (e.g., a first residual block B0, a second residual block B1, to a seventh residual block B6, and an eighth residual block B7) from which the quantized mean values 330 corresponding to each of the eight (8) sub-blocks B0to B7 have been removed.

In an embodiment, as the sub-block size decreases, the likelihood of artifacts during reconstruction may decrease, while the amount of transmission may increase. Therefore, the electronic device may flexibly adjust the size of sub-blocks based on a balance between a compression ratio and an image quality.

According to an embodiment, the electronic device may generate a residual image by employing both the method of dividing an original image into image blocks by color, as described with reference to FIG. 5, and the method of further dividing the image blocks into sub-blocks, as described with reference to FIG. 7.

For example, the electronic device may divide an image block of a Bayer pattern image sized 4×64 into eight (8) sub-blocks sized 4×8 and then calculate and quantize mean values for each color in each of the eight (8) 4×8 sub-blocks. The electronic device may generate a residual image by removing quantized mean values for each color from each of the eight (8) sub-blocks of size 4×8. In such an example, the electronic device may need to transmit a total of 32 mean values (e.g., 4 colors×8 sub-blocks) to the decoder, which may increase the total amount of transmission but may improve reconstruction quality by preserving information about mean values for each color and position.

FIG. 8 is a diagram illustrating a method of transmitting representative values to a neural decoder by an electronic device, according to an embodiment. Referring to FIG. 8, a diagram illustrates a method of transmitting a latent vector together with representative values to a neural decoder (e.g., the decoding module 114, the decoding module 124, or the decoder 270) by the electronic device (e.g., the electronic device 100 or 200), according to an embodiment.

For example, the electronic device may construct a bit stream 810 by combinin eight (8) quantized mean values (e.g., a first quantized mean value \hat{μ} _{B}_{₀}, a second quantized mean value \hat{μ} _{B}_{₁}, a third quantized mean value \hat{μ} _{B}_{₂}, to an eighth quantized mean value \hat{μ} _{B}_{₇}), each quantized mean value corresponding to a sub-block and being represented by eight (8) bits, together with a latent vector, and transmit the bit stream 810 to the neural decoder (e.g., the decoding module 114, the decoding module 124, or the decoder 270). That is, the electronic device may consume (construct) a bit stream 810 containing a total of 64 bits (e.g., 8 bits×8 quantized mean values) of transmission for transmitting the eight (8) quantized mean values \hat{μ}_{B}_{₀} to \hat{μ}_{B}_{₇}.

Instead of directly transmitting the eight (8) 8-bit mean values, the electronic device may transmit a mean difference r_{B}_{ₙ} 850 between a previous sub-block mean value \hat{μ}_{B}_{ₙ}⁻¹ and a current sub-block mean value \hat{μ}_{B}_{ₙ}. Since mean values of adjacent sub-blocks are likely similar, the electronic device may reduce the amount of transmission by transmitting only the mean difference r_{B}_{ₙ} 850 relative to the mean value of the previous sub-block (e.g., \hat{μ}_{B}_{ₙ}−μ_{B}_{₁}), instead of transmitting the full 8-bit mean value. For example, when the mean value of the previous sub-block μ_{B}ⁿ⁻¹ is 36 and the mean value of the current sub-block \hat{μ}_{B}_{ₙ} is 42, the electronic device may transmit a mean difference of six (6) between the previous sub-block mean value \hat{μ}_{B}_{ₙ}⁻¹ (e.g., 36) and the current sub-block mean value \hat{μ}_{B}_{ₙ} (e.g., 42). In such an example, since the mean difference of six (6) may be represented using only three (3) bits, the electronic device may reduce the amount of transmission by transmitting three (3) bits rather than eight (8) bits. However, the present disclosure is not limited in this regard, and the mean values may be different from the ones described above, and consequently, different numbers of bits may be used to represent the full mean values, as well as, the difference values.

In an embodiment, the electronic device may transmit a bit stream 830 including the mean difference r_{B}_{ₙ} 850. As such, the neural decoder that receives the bit stream 830 including the mean difference r_{B}_{ₙ} 850 may require length information of a mean value \hat{μ} of each sub-block to read the bit stream 830. However, a mean difference between mean values \hat{μ} of adjacent sub-blocks may vary depending on data and may vary within a range of zero (0) to eight (8) bits, for example. If a fixed reference value (e.g., three (3) bits) is set, and the mean difference r_{B}_{ₙ} 850 may be represented within the reference value, the electronic device may transmit the mean difference r_{B}_{ₙ} 850, otherwise, if the mean difference r_{B}_{ₙ} 850 exceeds the reference value, the electronic device may transmit the original mean value \hat{μ} in its original form. That is, the electronic device may transmit the mean difference r_{B}_{ₙ} 850 if the difference between the mean value \hat{μ}_{B}_{ₙ}⁻¹ of the previous sub-block and the mean value \hat{μ}_{B}_{ₙ} of the current sub-block is less than the reference value (e.g., three (3) bits or a value of eight (8)) and may transmit the mean value \hat{μ} if the difference is greater than or equal to the reference value (e.g., three (3) bits or a value of eight (8)).

In an embodiment, if the mean difference rBn 850 is transmitted, the electronic device may set the value of a flag 870 to a first value (e.g., one or ‘1’) and may transmit the flag 870. Alternatively or additionally, if the mean value \hat{μ} is transmitted, the electronic device may set the value of the flag 870 to a second value (e.g., zero or ‘0’) and may transmit the flag 870. The electronic device may transmit a value (e.g., the mean value \hat{μ} or the mean difference r_{B}_{ₙ} 850) together with the flag 870, thereby enabling the receiving side to identify whether the transmitted bits indicate the mean value \hat{μ} or the mean difference r_{B}_{ₙ} 850, and thereby, increasing a compression ratio by reducing the length of the transmitted bit stream, when compared to related image processing methods.

In an embodiment of FIG. 8, when all the eight (8) sub-blocks transmit mean values, the length of the bit stream may be 64 bits (e.g., 8 mean values×8 bits. However, if the mean difference r_{B}_{ₙ} 850 is transmitted instead of the mean value \hat{μ} for five out of the eight sub-blocks, the total length of the bit stream may be 47 bits (e.g., (8+1) bits×(8−5) mean values +(3+1) bits×5 mean values), thereby reducing the amount of transmission by 17 bits (e.g., 64 bits−47 bits). However, the present disclosure is not limited in this regard, and the mean values may be different from the ones described above, and consequently, different numbers of bits may be used to stream the mean values, as well as, result in different bit reductions.

When transmitting the bit stream 810 or the bit stream 830, the electronic device may transmit sub-blocks at adjacent positions together or transmit sub-blocks separately for each channel. Alternatively or additionally, the electronic device may sequentially transmit sub-blocks at adjacent positions within a channel. For example, the electronic device may transmit a first sub-block, a second sub-block, to a k-th sub-block on a first channel and transmit a (k+1)-th sub-block, a (k+2)-th sub-block, to an n-th sub-block on a second channel, where n is a positive integer greater than one (1), and k is a positive integer less than n. As another example, the electronic device may transmit a first sub-block, a third sub-block, to an (n-1)-th sub-block on the first channel and transmit a second sub-block, a fourth sub-block, to an n-th sub-block on the second channel. However, embodiments of the present disclosure are not limited in this regard, and the sub-blocks may be transmitted by the electronic device in various other manners over various numbers of channels.

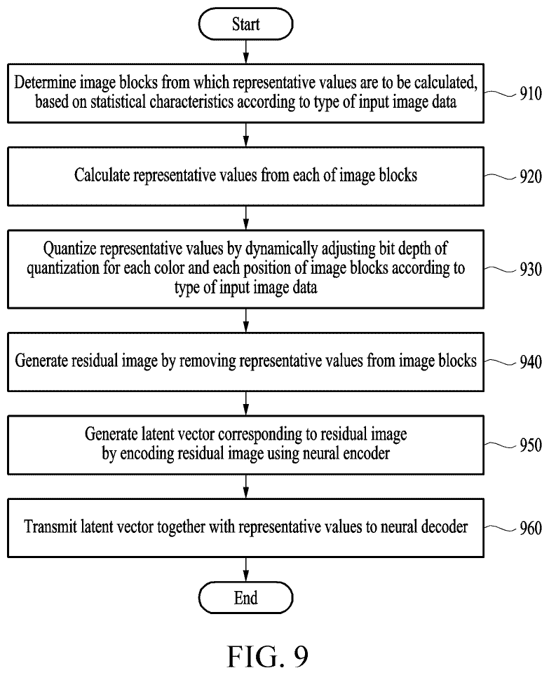

FIG. 9 is a flowchart illustrating an image processing method of an electronic device using a neural encoder, according to an embodiment. Referring to FIG. 9, the electronic device (e.g., the electronic device 100 or 200), according to an embodiment may transmit compressed data (e.g., a latent vector) together with representative values to a neural decoder (e.g., the decoding module 114, the decoding module 124, or the decoder 270) through operations 910 to 960.

In operation 910, the electronic device may determine image blocks from which representative values are to be calculated, based on the statistical characteristics of each type of input image data.

In operation 920, the electronic device may calculate representative values from each of the image blocks determined in operation 910.

In operation 930, the electronic device may quantize the representative values calculated in operation 920 by dynamically adjusting the bit depth of quantization for each color and position of the image blocks according to the type of input image data.

In operation 940, the electronic device may generate a residual image by removing the representative values quantized in operation 930 from the image blocks.

In operation 950, the electronic device may generate a latent vector corresponding to the residual image by encoding the residual image generated in operation 940 using the neural encoder.

In operation 960, the electronic device may transmit the latent vector generated in operation 950 together with the representative values to the neural decoder.

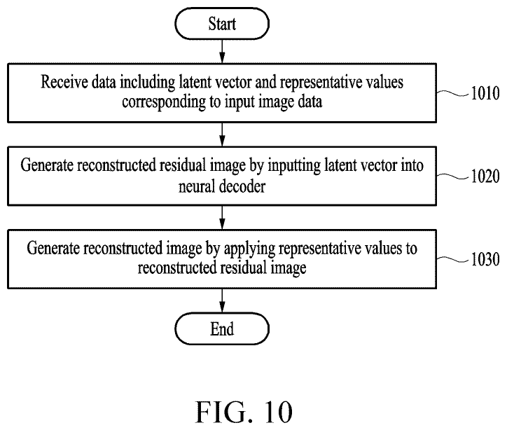

FIG. 10 is a flowchart illustrating an image processing method of an electronic device using a neural decoder, according to an embodiment. Referring to FIG. 10, the electronic device (e.g., the electronic device 100 or 200), according to an embodiment, may generate a reconstructed image through operations 1010 to 1030.

In operation 1010, the electronic device may receive data including a latent vector and representative values corresponding to input image data.

In operation 1020, the electronic device may generate a reconstructed residual image by inputting the latent vector included in the data received in operation 1010 into the neural decoder.

In operation 1030, the electronic device may generate a reconstructed image by applying the representative values included in the data received in operation 1010 to the residual image reconstructed in operation 1020. For example, the electronic device may read the value of a flag included in the received data. The electronic device may generate a reconstructed image by applying the representative values to the reconstructed residual image in response to the value of the flag.

In addition, the electronic device may add a certain number of LSBs to a bit stream representing representative values. The electronic device may generate a reconstructed image by applying, to the reconstructed residual image, representative values with the added certain number of LSBs.

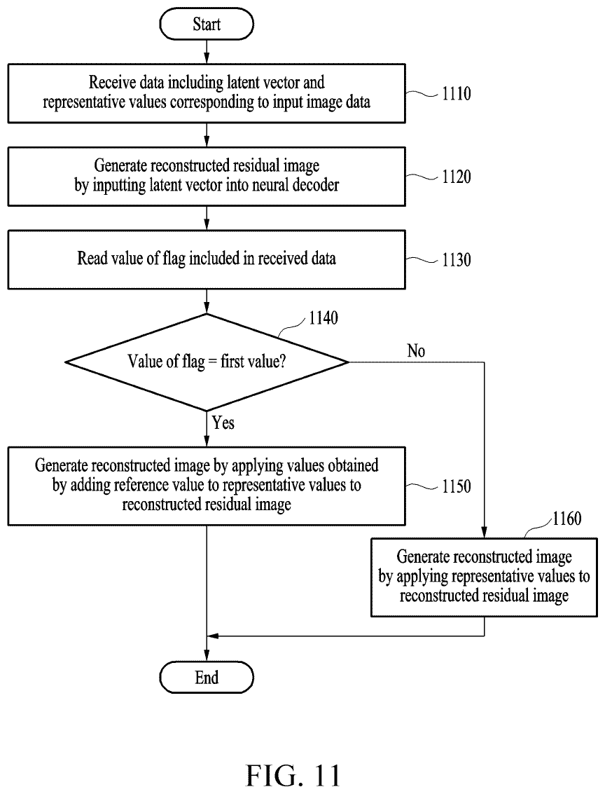

FIG. 11 is a flowchart illustrating an image processing method of an electronic device using a neural decoder, according to an embodiment. Referring to FIG. 11, the electronic device (e.g., the electronic device 100 or 200), according to an embodiment, may generate a reconstructed image through operations 1110 to 1160.

In operation 1110, the electronic device may receive data including a latent vector and representative values corresponding to input image data.

In operation 1120, the electronic device may generate a reconstructed residual image by inputting the latent vector included in the data received in operation 1110 into the neural decoder.

In operation 1130, the electronic device may read the value of a flag included in the data received in operation 1110.

In operation 1140, the electronic device may determine whether the value of the flag read in operation 1130 corresponds to a first value (e.g., one or ‘1’). If the value of the flag is determined to be the first value (e.g., one or ‘1’) in operation 1140 (Yes in operation 1140), then in operation 1150, the electronic device may generate a reconstructed image by applying values obtained by adding a reference value to the representative values to the reconstructed residual image.

If the value of the flag is determined to be a second value (e.g., zero or ‘0’) in operation 1140 (No in operation 1140), then in operation 1160, the electronic device may generate a reconstructed image by applying the representative values to the reconstructed residual image.

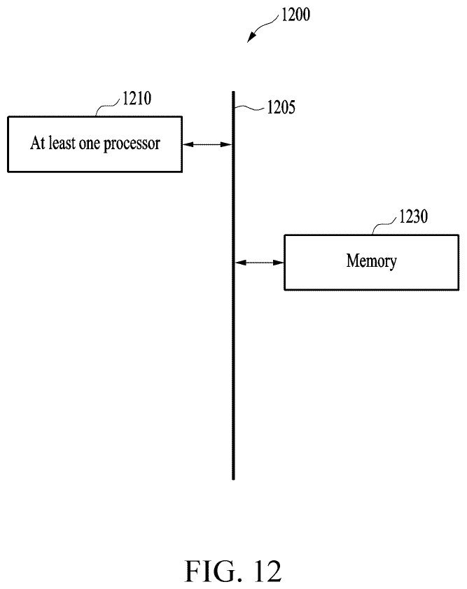

FIG. 12 is a block diagram illustrating an electronic device for performing image processing using a neural encoder, according to an embodiment.

Referring to FIG. 12, an electronic device 1200 may include and/or may be similar in many respects to the electronic device 100 or the electronic device 200 described above with reference to FIGS. 1 to 11, and may include additional features not mentioned above. Consequently, repeated descriptions of the electronic device 1200 described above with reference to FIGS. 1 to 11 may be omitted for the sake of brevity.

As shown in FIG. 12, according to an embodiment, the electronic device 1200 may perform image processing using a neural encoder (e.g., the encoding module 112, the encoding module 122, or the encoder 220) and includes at least one processor 1210 and memory 1230. The at least one processor 1210 and the memory 1230 may be connected to each other via a communication bus 1205.

The at least one processor 1210 may include and/or may be similar in many respects to the first processor 110 and the second processor 120 described above with reference to FIGS. 1 to 11, and may include additional features not mentioned above. Furthermore, the memory 1230 and the communication bus 1205 may include and/or may be similar in many respects to the memory 130 and the communication bus 140, respectively, described above with reference to FIG. 1, and may include additional features not mentioned above. Consequently, repeated descriptions of the at least one processor 1210, the memory 1230, and the communication bus 1205 described above with reference to FIGS. 1 to 11 may be omitted for the sake of brevity.

The number and arrangement of components of the electronic device 1200 shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Alternatively or additionally, a set of (one or more) components shown in FIG. 12 may be integrated with each other, and/or may be implemented as an integrated circuit, as software, and/or a combination of circuits and software. For example, in some embodiments, the at least one processor 1210, the memory 1230, and the communication bus 1205 may be included in a SoC.

The at least one processor 1210 may include processing circuitry. The at least one processor 1210 may perform at least one method described with reference to FIGS. 1 to 11 or an algorithm corresponding to the at least one method. The at least one processor 1210 may be and/or may include a hardware-implemented data processing device having a circuit that is physically structured to execute desired operations. The desired operations may include, for example, codes and/or instructions included in a program. The at least one processor 1210 may be implemented as, for example, a CPU, a GPU, or an NPU. The at least one processor 1210 may include, for example, a microprocessor, a CPU, a processor core, a multi-core processor, a multiprocessor, an ASIC, an FPGA, or the like.

The at least one processor 1210 may execute a program and control the electronic device 1200. Code of the program executed by the at least one processor 1210 may be stored in the memory 1230.

The memory 1230 may store a plurality of instructions. The plurality of instructions may be executed individually or collectively by the at least one processor 1210. The plurality of instructions may cause the electronic device 1200 to calculate representative values from image blocks of input image data, the blocks being set based on statistical characteristics of the input image data, generate a residual image by removing the representative values from the image blocks according to the type of the input image data, input the residual image into a neural encoder and encode the residual image to generate a latent vector corresponding to the residual image, and transmit the latent vector together with the representative values to a neural decoder.

The memory 1230 may store a neural network. The neural network may be and/or may include, for example, an entropy coder for performing entropy coding and/or a neural encoder for performing compression on image data. However, embodiments of the present disclosure are not necessarily limited thereto. The neural encoder may operate in a manner compatible with a standard video codec. A bit stream generated by the neural encoder may be interpreted by a decoder of a standard video codec and/or may be reconstructed into an image by any video decoder compliant with the same standard. The neural encoder may train a neural network such that an output corresponding to each of a plurality of input frames may be processed by a standard decoder. The standard decoder may include, for example, High Efficiency Video Coding (HEVC). However, embodiments of the present disclosure are not necessarily limited thereto, and the standard decoder may conform with one or more standard compression/decompression standards. The neural encoder may train the neural network by using, for example, unsupervised learning, self-supervised learning, or the like. The neural network may include a deep neural network (DNN). Alternatively or additionally, the neural network may include at least one of a convolutional neural network (CNN), a recurrent neural network (RNN), a perceptron, a multilayer perceptron (MLP), a feedforward network (FF), a radial basis function network (RBF), a deep feedforward network (DFF), a long short-term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural Turing machine (NTM), a capsule network (CN), a Kohonen network (KN), a binarized neural network (BNN), a transformer, an attention network (AN), or the like. As used herein, a neural network may refer to a model in which artificial neurons (or nodes) may form a network through synaptic connections, and the strength of the synaptic connections may be adjusted through training and/or machine learning to acquire problem-solving capabilities. An artificial neuron of a neural network may include a combination of weights and/or biases, and the neural network may include one or more layers including a plurality of artificial neurons. The neural encoder may perform unsupervised learning, for example, using rate-distortion (RD) loss. However, embodiments of the present disclosure are not limited in this regard, and different criteria may be used to perform training and/or learning of the neural encoder and/or the neural decoder.

The memory 1230 may be and/or may include at least one of a volatile memory device or a non-volatile memory device. The volatile memory device may be and/or may include DRAM, static random-access memory (SRAM), thyristor RAM (T-RAM), zero capacitor RAM (Z-RAM), twin transistor RAM (TTRAM), or the like. The non-volatile memory device may be and/or may include electrically erasable programmable read-only memory (EEPROM), flash memory, magnetic RAM (MRAM), spin-transfer torque MRAM (STT-MRAM), conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, insulator resistance change memory, or the like.

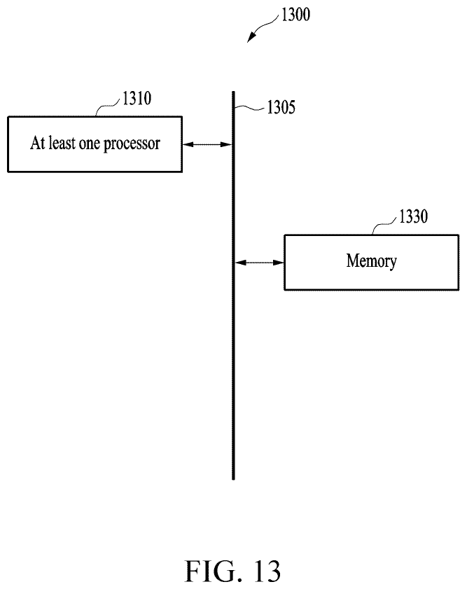

FIG. 13 is a block diagram illustrating an electronic device for performing image processing using a neural decoder, according to an embodiment.

Referring to FIG. 13, an electronic device 1300 may include and/or may be similar in many respects to the electronic device 100, the electronic device 200, or the electronic device 1200 described above with reference to FIGS. 1 to 12, and may include additional features not mentioned above. Consequently, repeated descriptions of the electronic device 1300 described above with reference to FIGS. 1 to 12 may be omitted for the sake of brevity.

As shown in FIG. 13, according to an embodiment, the electronic device 1300 may perform image processing using a neural decoder (e.g., the decoding module 114, the decoding module 124, or the decoder 270) and includes at least one processor 1310 and memory 1330. The at least one processor 1310 and the memory 1330 may be connected to each other via a communication bus 1305.

The at least one processor 1310 may include and/or may be similar in many respects to the first processor 110, the second processor 120, and the at least one processor 1210 described above with reference to FIGS. 1 to 12, and may include additional features not mentioned above. Furthermore, the memory 1330 and the communication bus 1305 may include and/or may be similar in many respects to the memories 130 and 1230 and the communication buses 140 and 1205, respectively, described above with reference to FIGS. 1 and 12, and may include additional features not mentioned above. Consequently, repeated descriptions of the at least one processor 1310, the memory 1330, and the communication bus 1305 described above with reference to FIGS. 1 to 12 may be omitted for the sake of brevity.

The number and arrangement of components of the electronic device 1300 shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Alternatively or additionally, a set of (one or more) components shown in FIG. 13 may be integrated with each other, and/or may be implemented as an integrated circuit, as software, and/or a combination of circuits and software. For example, in some embodiments, the at least one processor 1310, the memory 1330, and the communication bus 1305 may be included in a SoC.

The at least one processor 1310 may include processing circuitry. The at least one processor 1310 may perform at least one method described with reference to FIGS. 1 to 11 or an algorithm corresponding to the at least one method. The at least one processor 1310 may be and/or may include a hardware-implemented data processing device having a circuit that is physically structured to execute desired operations. The desired operations may include, for example, codes and/or instructions included in a program. The at least one processor 1310 may be implemented as, for example, a CPU, a GPU, or an NPU. The at least one processor 1310 may include, for example, a microprocessor, a CPU, a processor core, a multi-core processor, a multiprocessor, an ASIC, an FPGA, or the like.

The at least one processor 1310 may execute a program and control the electronic device 1300. Code of the program executed by the at least one processor 1310 may be stored in the memory 1330.

The memory 1330 stores a plurality of instructions executable by the at least one processor 1310. The plurality of instructions may be executed individually or collectively by the at least one processor 1310. The plurality of instructions may cause the electronic device 1300 to receive data including a latent vector and representative values corresponding to input image data, input the latent vector into a neural decoder to generate a reconstructed residual image, and apply the representative values to the reconstructed residual image to generate a reconstructed image.

In addition, the memory 1330 may store a neural network. The neural network may be and/or may include, for example, an entropy decoder for performing entropy decoding and/or a neural decoder for performing decompression or restoration on compressed image data. However, embodiments of the present disclosure are not necessarily limited thereto. The neural decoder may train the neural network by using, but not limited to, for example, unsupervised learning, self-supervised learning, or the like. The neural network may include a DNN. Alternatively or additionally, the neural network may include at least one of a CNN, an RNN, a perceptron, a MLP, a FF, an RBF, a DFF, a LSTM, a GRU, an AE, a VAE, a DAE, a SAE, a MC, a HN, a BM, an RBM, a DBN, a DCN, a DN, a DCIGN, a GAN, a LSM, an ELM, an ESN, a DRN, a DNC, a NTM, a CN, a KN, a BNN, a transformer, an, or the like. As used herein, a neural network may refer to a model in which artificial neurons (or nodes) may form a network through synaptic connections, and the strength of the synaptic connections may be adjusted through training and/or machine learning to acquire problem-solving capabilities. An artificial neuron of a neural network may include a combination of weights and/or biases, and the neural network may include one or more layers including a plurality of artificial neurons.

The memory 1330 may be and/or may include at least one of a volatile memory device or a non-volatile memory device. The volatile memory device may be and/or may include DRAM, SRAM, T-RAM, Z-RAM, TTRAM, or the like. The non-volatile memory device may be and/or may include EEPROM, flash memory, MRAM, STT-MRAM, CBRAM, FeRAM, PRAM, RRAM, nanotube RRAM, PoRAM, NFGM, holographic memory, a molecular electronic memory device, insulator resistance change memory, or the like.

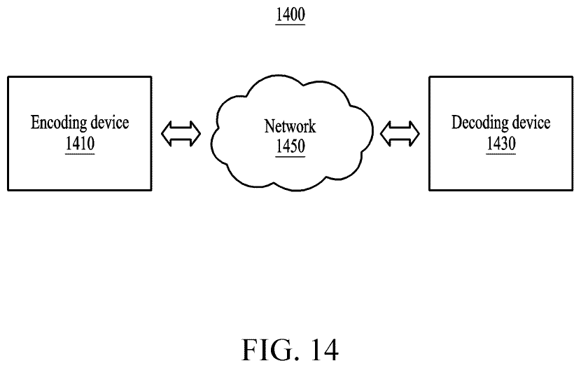

FIG. 14 is a diagram illustrating an image processing system, according to an embodiment. Referring to FIG. 14, an image processing system 1400, according to an embodiment, may include an encoding device 1410 that performs encoding, a decoding device 1430 that performs decoding, and a network 1450 communicatively coupling the encoding device 1410 with the decoding device 1430.

The encoding device 1410 may include and/or may be similar in many respects to the electronic device 100, the electronic device 200, the electronic device 1200, or an electronic device including the encoding module 112, the encoding module 122, or the encoder 220 described above with reference to FIGS. 1 to 12, and may include additional features not mentioned above. The decoding device 1430 may include and/or may be similar in many respects to the electronic device 100, the electronic device 200, the electronic device 1300, or an electronic device including the decoding module 114, the decoding module 124, or the decoder 270 described above with reference to FIGS. 1 to 11 and 13, and may include additional features not mentioned above. Consequently, repeated descriptions of the encoding device 1410 and the decoding device 1430 described above with reference to FIGS. 1 to 13 may be omitted for the sake of brevity.

The encoding device 1410 may process (e.g., encode) video data, such as a video including a plurality of frames, a single image, or a moving image, and transmit the processed video data to an external device (e.g., the decoding device 1430). For example, the encoding device 1410 may be an electronic device, such as, but not limited to, a content providing device that may provide video content, a video broadcasting device, a terminal that transmits video in a video call or video conference, or the like. The encoding device 1410 may encode (or compress) all or at least a portion of the image data to generate encoded data with a reduced data size, thereby reducing the amount of image data to be transmitted and increasing the transmission speed.

The encoding device 1410 may include a neural encoder (e.g., the encoding module 112, the encoding module 122, or the encoder 220) that performs an encoding process of compressing input image data to generate a latent vector and/or a bit stream but is not necessarily limited thereto.

Image data (e.g., compressed image data) processed by the encoding device 1410 may be transmitted (or delivered) to the decoding device 1430 via the network 1450. In embodiments, the image data transmitted from the encoding device 1410 to the decoding device 1430 may include feature information (e.g., a feature map, a latent vector, and/or a bit stream) extracted from original image data through an encoding process. However, embodiments of the present disclosure are not necessarily limited thereto.

The network 1450 may include, but not be limited to, a wired cable network, a short-range wireless network, a long-range wireless network, or the like. The short-range wireless network may include, but not be limited to, for example, Bluetooth™, wireless fidelity (Wi-Fi), infrared data association (IrDA), or the like. The long-range wireless network may include, but not be limited to, a legacy cellular network, a third generation (3G) network, a fourth generation (4G) network, a fifth generation (5G) network, a next-generation communication network, the Internet, a computer network (e.g., a local area network (LAN) or a wide area network (WAN)), or the like.

The decoding device 1430 may receive image data (or encoded feature information) that has been encoded by the encoding device 1410 via the network 1450. In an embodiment, encoded image data generated by the encoding device 1410 may be transmitted to the decoding device 1430 directly via the network 1450 or via one or more other devices. The decoding device 1430 may be implemented in various forms of electronic devices. The decoding device 1430 may include, but not be limited to, for example, a portable communication device (e.g., a smartphone), a computing device, a portable multimedia device (e.g., a tablet PC), a camera, a wearable device, a set-top box (STB), a video streaming device, a content storage device, a home appliance (e.g., a TV), or the like. An electronic device, according to embodiments of the present disclosure, may not limited to the devices described above.

The decoding device 1430 may process encoded image data to provide video to a user. For example, the decoding device 1430 may decode encoded image data and provide reconstructed image data to the user. Through encoding performed by the encoding device 1410, the data size of the original image data may be reduced. However, some information included in the original image data may be lost during the encoding process. The decoding device 1430 may reconstruct information lost during the encoding process of image data through decoding, thereby generating image data with higher image quality than the encoded image data.

The decoding device 1430 may include, but is not limited to, a neural network-based neural decoder (e.g., the decoding module 114, the decoding module 124, or the decoder 270) that may perform a decoding process to reconstruct features lost during the encoding process by restoring (or decompressing) encoded (or compressed) image data. The neural network may refer to a model in which artificial neurons (or nodes), forming a network through synaptic connections, may acquire problem-solving capabilities by adjusting the strength of the synaptic connections through training and/or machine learning. Artificial neurons of the neural network may include a combination of weights and/or biases, and the neural network may include one or more layers each including a plurality of artificial neurons.

The image processing system 1400 may be implemented in a PC, a cloud server, a data server, a portable device, or the like. The portable device may be implemented as a laptop computer, a mobile phone, a smartphone, a tablet computer, an MID, a PDA, an EDA, a digital still camera, a digital video camera, a PMP, a PND, a handheld game console, an e-book, a smart device, or the like. The smart device may be implemented as a smart watch, a smart band, a pair of smart glasses, a smart ring, or the like.

The examples described herein may be implemented by using a hardware component, a software component, and/or a combination thereof. A processing device may be implemented using one or more general-purpose or special-purpose computers, such as, but not limited to, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit may be used as singular. However, one skilled in the art may appreciate that a processing unit may include a plurality of processing elements and a plurality of types of processing elements. For example, the processing unit may include a plurality of processors, or a single processor and a single controller. In addition, different processing configurations may be possible, such as, but not limited to, parallel processors.

The software may include a computer program, a piece of code, an instruction, or some combination thereof, to independently and/or uniformly instruct and/or configure the processing device to operate as desired. Software and data may be stored permanently and/or temporarily in any type of machine, component, physical or virtual equipment, computer storage medium, or device capable of providing instructions and/or data to and/or being interpreted by the processing device. The software may also be distributed over network-coupled computer systems so that the software may be stored and/or executed in a distributed fashion. The software and/or data may be stored by one or more non-transitory computer-readable recording mediums.

The methods, according to the above-described examples, may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media may include magnetic media (e.g., hard disks, floppy disks, magnetic tape, or the like), optical media (e.g., compact disc (CD) ROM (CD-ROM) discs, digital versatile discs (DVDs), or the like), magneto-optical media (e.g., optical discs), hardware devices that may be specially configured to store and perform program instructions (e.g., read-only memory (ROM), random-access memory (RAM), flash memory, or the like), or the like. Examples of program instructions may include both machine code, such as produced by a compiler, and/or files containing higher-level code that may be executed by the computer using an interpreter.

The above-described devices may act as one or more software modules in order to perform the operations of the above-described examples, or vice versa.

As described above, although the examples have been described with reference to the drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. Therefore, other implementations, other examples, and equivalents to the claims are also within the scope of the following claims.

What is claimed is:

1. An image processing method of an electronic device, the image processing method comprising:
calculating representative values by dividing input image data into image blocks based on statistical characteristics corresponding to a type of the input image data;
generating a residual image by removing the representative values from the image blocks, respectively;
encoding, using a neural encoder, the residual image into a latent vector; and
transmitting, to a neural decoder, the latent vector and the representative values.

2. The image processing method of claim 1, wherein the calculating of the representative values comprises:
determining, based on the statistical characteristics, the image blocks of the input image data from which the representative values are to be calculated; and
calculating the representative values from each of the image blocks.

3. The image processing method of claim 2, wherein the determining of the image blocks comprises:
determining the image blocks for each channel of the input image data.

4. The image processing method of claim 3, wherein the calculating of the representative values from each of the image blocks comprises:
calculating the representative values by averaging channel values of each of the image blocks.

5. The image processing method of claim 3, wherein the determining of the image blocks comprises:
dividing the image blocks into a plurality of sub-blocks.

6. The image processing method of claim 5, wherein the calculating of the representative values comprises:
calculating the representative values by averaging values of the plurality of sub-blocks.

7. The image processing method of claim 1, wherein the generating of the residual image comprises:
quantizing the representative values; and
generating the residual image by removing the quantized representative values from the image blocks.

8. The image processing method of claim 7, wherein the quantizing of the representative values comprises:
dynamically adjusting a bit depth of a quantization for each color of the image blocks based on the type of the input image data; and
dynamically adjusting the bit depth of a quantization for each position of the image blocks based on the type of the input image data.

9. The image processing method of claim 7, wherein the quantizing of the representative values comprises:
reducing a length of a bit stream by removing at least one least significant bit from the bit stream representing the representative values; and
quantizing the reduced bit stream.

10. The image processing method of claim 7, wherein the generating of the residual image comprises:
adjusting the quantized representative values; and
generating the residual image by removing the adjusted representative values from the image blocks.

11. The image processing method of claim 7, wherein the transmitting of the latent vector comprises:
transmitting, to the neural decoder, the latent vector combined with the quantized representative values.

12. The image processing method of claim 6, wherein the transmitting of the latent vector comprises:
transmitting, to the neural decoder, the latent vector, a difference value between a representative value of a current sub-block and a representative value of an adjacent previous sub-block, and a flag.

13. The image processing method of claim 12, wherein the transmitting of the latent vector further comprises:
transmitting, to the neural decoder, the flag indicating a first value and the difference value, based on the difference value being less than a reference value; and
transmitting, to the neural decoder, the flag indicating a second value and the representative values, based on the difference value being greater than or equal to the reference value.

14. The image processing method of claim 1, wherein the type of the input image data comprises at least one of a Bayer pattern image, a luminance-chrominance (YUV) image, or a red, green, and blue (RGB) image.

15. An image processing method of an electronic device, the image processing method comprising:
receiving data comprising a latent vector and representative values corresponding to input image data;
generating, using a neural decoder, a reconstructed residual image by inputting the latent vector into the neural decoder; and
applying the representative values to the reconstructed residual image to generate a reconstructed image.

16. The image processing method of claim 15, wherein the generating of the reconstructed image comprises:
reading a value of a flag comprised in the received data; and
generating the reconstructed image by applying the representative values to the reconstructed residual image based on the value of the flag.

17. The image processing method of claim 16, wherein the generating of the reconstructed image comprises:
based on the flag indicating a first value, applying, to the reconstructed residual image, a reconstruction value obtained by adding a reference value to the representative values; and
based on the flag indicating a second value, applying the representative values to the reconstructed residual image.

18. The image processing method of claim 15, further comprising:
adding at least one least significant bit (LSB) to a bit stream representing the representative values, and
wherein the generating of the reconstructed image comprises:
applying, to the reconstructed residual image, the representative values with the added at least one LSB.

19. An electronic device for performing image processing, the electronic device comprising:
at least one processor comprising processing circuitry; and
memory storing a plurality of instructions,
wherein the plurality of instructions, when executed individually or collectively by the at least one processor, cause the electronic device to:
calculate representative values from image blocks of input image data set based on statistical characteristics of the input image data;
generate a residual image by removing the representative values from the image blocks corresponding a type of the input image data;
encode, using a neural encoder, the residual image into a latent vector; and
transmit, to a neural decoder, the latent vector and the representative values.

20. The electronic device of claim 19, wherein the plurality of instructions, when executed individually or collectively by the at least one processor, further cause the electronic device to:
determine, based on the statistical characteristics corresponding to the type of the input image data, the image blocks of the input image data from which the representative values are to be calculated; and
calculate the representative values from each of the image blocks.
